(19) United States
(12) Patent Application Publication
(10) Pub. No.: US 2013/0006798 A1
(43) Pub. Date: Jan. 3, 2013

(54) Penny Auction With Reserve

(76) Inventors: Michael Yushuva, Penacook, NH (US); Elina Kaziyeva, Penacook, NH (US)

(21) Appl. No.: 13/170,310

(22) Filed: Jun. 28, 2011

(51) Int. Cl. G06Q 30/00

(52) U.S. Cl. 705/26.3

(57) ABSTRACT

A method of conducting an on-line auction comprises selecting a product with a reserve price set by the seller which is less or more than one dollar. Starting the auction by placing product and reserve price on the web, accepting bids that are in increments of dollar amounts or in pennies and providing a count down time period during which bidding continues until the reserve price is reached or the count down clock reaches zero. If the reserve price is reached before count down to zero is reached, bidding is restricted only to prior bidders and continues without new bidders up to the end of the count down time period at which time the highest bidder wins. If the reserve price is not met before the count down time ends, the bidders get their bids back.

### BACKGROUND OF THE INVENTION

1. Field of the Invention

The present invention relates generally to the field of online auctions and more specifically to penny auction in combination with a reserve price.

2. Description of Related Art

On-line auctions are an increasingly popular vehicle for buying and selling merchandise and are known in the prior art. More specifically, by way of example, U.S. PreGrant Publication No. 2010/0332295 to Rochman discloses accepting bids for associated different items in an online auction management system where two items are of a different item type and, where determining winning bids amongst accepted bids is by comparing the accepted bids to one another without regard to whether or not the accepted bids had been placed for an item of a specific item type.

U.S. PreGrant Publication No. 2004/0034590 to Zinberg discloses a very short initial time of 5 minutes or less in which the auction on a particular item is to take place. The auction closes at the end of the period, with the highest bidder obtaining the object. If, however, a bid is received during a pre-defined end portion of the initial period that is known to the bidders, the auction period is extended for a short supplemental period.

U.S. Pat. No. 7,315,832 to Bauer discloses a preliminary bidding portion which allows bidders to access auction items and input bids during a preestablished extended period of time. After the preliminary bidding portion ends, the auction provides bidders the opportunity to input bids on each item consecutively and individually from the preliminary auction portion in a manner similar to a conventional live auction.

U.S. Pat. No. 7,024,376 to Yuen discloses determining the most favorable advertised price for an item, based on a review of multiple vendors offering the item for sale. Then, a sale price which is lower than the most favorable advertised price is obtained by soliciting bids from multiple vendors of the item, where each bid represents an offer for sale of the item at a price lower than the most favorable advertised price.

U.S. Pat. No. 6,671,674 to Anderson, et al. discloses collecting a nonredeemable fee from each auction participant to enter the bidder pool for an item where the nonredeemable fees are then allocated to reduce the minimum bid required to purchase the item for the seller's asking price.

U.S. Pat. No. 6,606,607 to Martin, et al. discloses assigning a minimum acceptable price (MAP) as well as a virtual minimum acceptable price (VMAP) to a product where the VMAP is always greater than MAP. The bidder can submit as many as three bids with counter offers made to the first two bids. If the third bid is declined, the bidder is locked out of the bidding process

U.S. Pat. No. 6,044,363 to Mori, et al. discloses receiving orders from remote bidders which includes a desired price, and a highest possible price for each remote bidder; and conducting an automated auction procedure where the desired prices included in the ordering information are compared to determine an initial highest product price.

### SUMMARY OF THE INVENTION

In an exemplary embodiment of the present invention, there is disclosed a method of conducting an on-line auction comprising the steps of:

selecting a product for auction on the web with a reserve price that is set by the seller which is less or more than one dollar;

starting the auction by placing product and reserve price on the web;

accepting bids that are in increments of dollar amounts or in pennies:

providing a count down time period during which bidding of the product is to take place;

accepting no bids from new bidders upon reaching the reserve price prior to the auction reaching the end of the count down time period;

continuing with the bidding on the product without new bidders to the end of the count down time period;

closing the auction at the end of the count down period at which time the highest bidder wins; or

wherein the auction continues with all bidders until the count down time period is reached;

wherein if the reserve price is not met before the end of the count down period the bidders get their bids back;

wherein seller determines how many new bidders there can be before reserve price is met;

wherein bids can be place on the auction by the seller or automatically before reserve price is met in order to help bidders reach the reserve price.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of a penny auction with reserve in accordance with the principles of the invention.

### DESCRIPTION OF THE PREFERRED EMBODIMENT

In the penny auction with a reserve price disclosed, the seller chooses a product to sell and the seller specifies the following:

The Reserve Price
Penny auction plus reserve price
Reserve price is a certain price (X) which is set by the seller
Once the product is posted, the action will consist of the following:
   Timer which will start at a set point and decrease Seller
      Will set a reserve price on product
         1) Reserve price met
         Auction closes for new bidders
         New bidders are not allowed to participate
         Only bidders that have been participating before the reserve price was met are allowed to participate for the “final bid/win”
         Time reaches zero auction is won by the highest bidder.
         2) Reserve price NOT met
         Time expires and reserve price has not been met
         Bidders get their bids back

In addition to specifying the reserve price the Seller has the ability to set the following functions, only if so desired
Time
How many new users can bid before reserve price is met (100, 200 or infinitely)
Who may bid by geographic location or by prior reservation or some other way after choosing the product and functions
Seller has the ability to place bids on the auction before reserve price is met in order to help bidders reach the reserve price, which can be done automatically or manually
After reserve price is met:
   The seller and new bidders are prohibited from bidding on the auction

Once Reserve price is met:
Time reaches zero, auction is won by the bidder, and the bidder has an ability to receive the product or to resell it for a fee

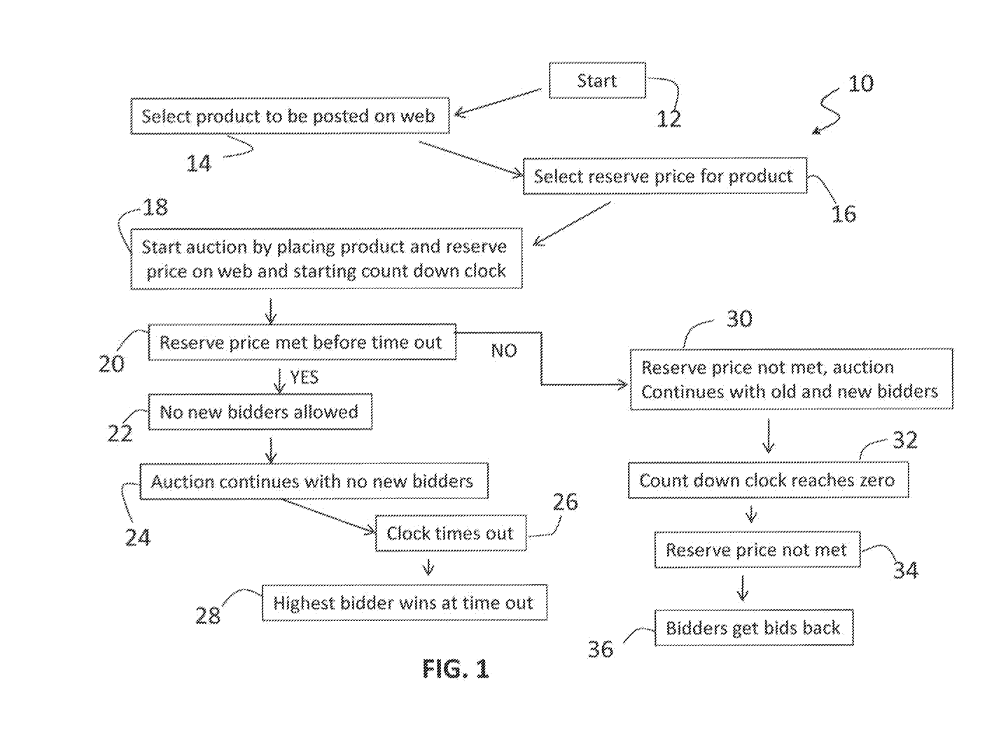

Referring to FIG. 1, there is disclosed a flow diagram of a penny auction with a reserve price 10 in accordance with the principles of the invention. At the start, block 12, a product that is to be auctioned is selected for posting on the web, block 14. A reserve price for the product is determined by the seller where the reserve price less or more than one dollar, such as $0.58, $2.00 $14.70, etc., and accepting bids that are in increments of dollar amounts or in pennies, such as $0.01, $1.12, $10.00 etc. block 16. Upon selecting the product and assigning a price, the product and the reserve price is placed on the web and a countdown clock is started, block 18. Soon thereafter the bidding starts and, at some time while the clock is still running the reserve price is either met or exceeded, block 20. Upon reaching or leapfrogging the reserve price, further bidding is closed to new bidders, block 22, and only those bidders who were bidding prior to the reserve price being reached can continue to bid for the product, block 24. At some time while the bidding is proceeding the count down clock reaches zero, block 26 and no new bids are accepted. The last bid received when the count down clock reached zero, which is the highest bid, is the winner of the auction, block 28.

Returning to block 20, the bidding for the product has started and is proceeding with new and prior bidders at a price which is below the reserve price, block 30. At some time while the bidding process is happening and the reserve price is not met, the count down clock reaches zero, block 32, the auction closes and no new bids are accepted. Since the reserve price has not been met when the count down clock reached zero, block 34, each bidder receives his/her bid s back, block 36.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of conducting an on-line auction comprising the steps of:
selecting a product for auction on the web with a reserve price that is set by the seller which is less or more than one dollar;
starting the auction by placing product and reserve price on the web;
accepting bids that are in increments of dollar amounts or in pennies;
providing a count down time period during which bidding of the product is to take place;
closing the auction only to new bidders upon reaching the reserve price prior to the auction reaching the count down time period;
continuing with the bidding on the product without new bidders up to the end of the count down time period; and
closing the auction at the end of the count down period at which time the highest bidder wins;
wherein seller determines how many new bidders there can be before reserve price is met;
wherein bids can be placed on the auction by the seller or automatically before reserve price is met in order to help bidders reach the reserve price.

2. The method of conducting an on-line auction of claim 1 wherein, when the reserve price is not reached, the auction continues with old and new bidders until the count down time period is reached; and
closing the auction at the end of the count down period at which time the bidders get their bids back if the reserve price has not been reached.

3. The method of conducting an on-line auction of claim 2 wherein, when the reserve price has been reached or exceeded, the highest bidder wins at the end of the count down period.

4. The method of conducting an on-line auction of claim 3 wherein the bidders bid for the product in increments of pennies, dollars or dollar and pennies.

5. A method of conducting an on-line auction comprising the steps of:
selecting a product for auction on the web with a reserve price that is set by the seller;
starting the auction by placing product and reserve price on the web;
providing a count down time period during which bidding of the product is to take place;
closing the auction only to new bidders upon reaching the reserve price prior to the auction reaching the count down time period;
continuing with the bidding on the product without new bidders up to the end of the count down time period; and
closing the auction at the end of the count down period at which time the highest bidder wins.
wherein the bidders bid for the product in increments of pennies.

6. The method of conducting an on-line auction of claim 5 wherein the auction continues with old and new bidders until the count down time period is reached; and
closing the auction at the end of the count down period at which time the bidders get their bids back if the reserve price has not been reached.

7. The method of conducting an on-line auction of claim 6 wherein the highest bidder wins at the end of the count down period when the reserve price has been met or exceeded.
